(19) United States
(12) Patent Application Publication
(10) Pub. No.: US 2022/0374864 A1
(43) Pub. Date: Nov. 24, 2022

(54) Method and System for Auto Filling of Payment Card Information in a Web Application

(71) Applicant: Visa International Service Association, San Francisco, CA (US)

(72) Inventor: Ved Prakash Sajjan K Agarwal, Dubai Marina, Dubai (AE)

(21) Appl. No.: 17/771,990

(22) PCT Filed: Nov. 4, 2019
(86) PCT No.: PCT/US19/59636

§ 371 Date: Apr. 26, 2022

(51) Int. Cl. G06Q 20/32; G06Q 20/40

(52) U.S. Cl. CPC G06Q 20/3276; G06Q 20/401; G06Q 20/409; G06Q 20/3272

(57) ABSTRACT

A method and system for auto filling of payment card information in a web application. The computer-implemented method includes receiving an input code, by an auto fill system configured in a device associated with a user, including one of an audio code or QR code from a payment card when the payment card is in proximity to the device. The received input code is transmitted to an issuing server of the payment card. Thereafter, the computer-implemented method includes receiving payment card information associated with the input code from the issuing server. Once the payment card information is received, the computer-implemented method includes auto filling the payment card information at a payment screen of a web application in the device for completing a transaction on the web application. The present disclosure provides an efficient and error free mechanism for filling of payment card information in a web application.

### BACKGROUND

### 1. Technical Field

The present subject matter is generally related to data processing and more particularly, but not exclusively, to methods and systems for auto filling of payment card information in a web application.

### 2. Technical Considerations

Several methods of payment for goods or services exist today, including cash, check, credit card, and debit card. Some of the most popular methods of payment include payment by credit card and debit card.

When using either form of transaction at a physical merchant location, the customer may swipe or insert the card into a terminal to perform the transaction. Alternatively, the transaction may also be initiated on the Internet. For example, a buyer may type a card number into appropriate payment fields on an online merchant payment webpage to pay for the goods or services provided by the online merchant.

However, one problem with paying for goods or services online is that the user must manually type all of the card information into the online payment page, including the card number, personal identification number (PIN), expiration date, and/or Card Verification Value (CVV), among other information. Entering all of this information for each online payment transaction may be tedious and error-prone.

### SUMMARY

In some non-limiting embodiments or aspects, provided is a computer-implemented method comprising: receiving, with at least one processor, an input code comprising one of an audio code or a QR code from a payment card of a user when the payment card is in proximity to a device associated with the user; transmitting, with at least one processor, the received input code to an issuing server of the payment card; receiving, with at least one processor, payment card information associated with the input code from the issuing server; and auto filling, with at least one processor, the payment card information at a payment screen of a web application in the device for completing a transaction on the web application.

In some non-limiting embodiments or aspects, the input code comprises a QR code, which is received upon scanning the QR code using an image capturing unit of the device when the payment card is in proximity to the device. In some non-limiting embodiments or aspects, the input code comprises an audio code, which is received through a microphone of the device when the payment card is in proximity to the device. In some non-limiting embodiments or aspects, the input code is received based on a selection by the user. In some non-limiting embodiments or aspects, the payment card information comprises at least one of the following: the name of the payment card holder, account number associated with the payment card, an expiry date of the payment card, a Card Verification Value (CVV), or any combination thereof. In some non-limiting embodiments or aspects, the method further comprises authenticating, with at least one processor, the user upon receiving a one time password (OTP) from the user, wherein the OTP is provided to the user by the issuing server of the payment card.

In some non-limiting embodiments or aspects, provided is an auto fill system comprising: one or more processors; and one or more computer-readable media, communicatively coupled to the one or more processors storing instructions; which upon execution causes the one or more processors to: receive an input code comprising one of an audio code or a QR code from a payment card when the payment card is in proximity to a device hosting the auto fill system; transmit the input code to an issuing server of the payment card; receive payment card information associated with the input code from the issuing server; and auto fill the payment card information at a payment screen of a web application in the device for completing a transaction on the web application.

In some non-limiting embodiments or aspects, the one or more processors receive the input code comprising a QR code upon scanning of the QR code using an image capturing unit of the device when the payment card is in proximity to the device. In some non-limiting embodiments or aspects, the one or more processors receive the input code comprising the audio code through a microphone of the device when the payment card is in proximity to the device. In some non-limiting embodiments or aspects, the one or more processors receive the input code upon selection by a user. In some non-limiting embodiments or aspects, the payment card information comprises at least one of the following: an account number associated with the payment card, an expiry date of the payment card, a Card Verification Value (CVV), or any combination thereof. In some non-limiting embodiments or aspects, the one or more processors authenticate the user upon receiving a one time password (OTP) from the user, wherein the OTP is provided to a user by the issuing server of the payment card.

In some non-limiting embodiments or aspects, provided is a non-transitory computer readable media including instructions stored thereon that when processed by at least one processor causes the at least one processor to: receive an input code comprising one of an audio code or a QR code from a payment card when the payment card is in proximity to a device hosting the auto fill system; transmit the input code to an issuing server of the payment card; receive payment card information associated with the input code from the issuing server; and auto fill the payment card information at a payment screen of a web application in the device for completing a transaction on the web application.

In some non-limiting embodiments or aspects, the instructions cause the at least one processor to receive the input code comprising a QR code upon scanning of the QR code using an image capturing unit of the device when the payment card is in proximity to the device. In some non-limiting embodiments or aspects, the instructions cause the at least one processor to receive the input code comprising the audio code through a microphone of the device when the payment card is in proximity to the device. In some non-limiting embodiments or aspects, the instructions cause the at least one processor to receive the input code upon selection by a user. In some non-limiting embodiments or aspects, the payment card information comprises at least one of the following: an account number associated with the payment card, an expiry date of the payment card, a Card Verification Value (CVV), or any combination thereof. In some non-limiting embodiments or aspects, the instructions cause the at least one processor to authenticate the user upon receiving a one time password (OTP) from the user, wherein the OTP is provided to a user by the issuing server of the payment card.

Further non-limiting embodiments or aspects are set forth in the following numbered clauses.

Clause 1: A computer-implemented method comprising: receiving, with at least one processor, an input code comprising one of an audio code or a QR code from a payment card of a user when the payment card is in proximity to a device associated with the user; transmitting, with at least one processor, the received input code to an issuing server of the payment card; receiving, with at least one processor, payment card information associated with the input code from the issuing server; and auto filling, with at least one processor, the payment card information at a payment screen of a web application in the device for completing a transaction on the web application.

Clause 2: The computer-implemented method of clause 1, wherein the input code comprises a QR code, which is received upon scanning the QR code using an image capturing unit of the device when the payment card is in proximity to the device.

Clause 3: The computer-implemented method of clause 1 or 2, wherein the input code comprises an audio code, which is received through a microphone of the device when the payment card is in proximity to the device.

Clause 4: The computer-implemented method of any of clauses 1-3, wherein the input code is received based on a selection by the user.

Clause 5: The computer-implemented method of any of clauses 1-4, wherein the payment card information comprises at least one of the following: a name of the payment card holder, an account number associated with the payment card, an expiry date of the payment card, a Card Verification Value (CVV), or any combination thereof.

Clause 6: The computer-implemented method of any of clauses 1-5, further comprising authenticating, with at least one processor, the user upon receiving a One Time Password (OTP) from the user, wherein the OTP is provided to the user by the issuing server of the payment card.

Clause 7: An auto fill system comprising: one or more processors; and one or more computer-readable media, communicatively coupled to the one or more processors storing instructions, which upon execution causes the one or more processors to: receive an input code comprising one of an audio code or a QR code from a payment card when the payment card is in proximity to a device hosting the auto fill system; transmit the input code to an issuing server of the payment card; receive payment card information associated with the input code from the issuing server; and auto fill the payment card information at a payment screen of a web application in the device for completing a transaction on the web application.

Clause 8: The auto fill system of clause 7, wherein the one or more processors receive the input code comprising a QR code upon scanning of the QR code using an image capturing unit of the device when the payment card is in proximity to the device.

Clause 9: The auto fill system of clause 7 or 8, wherein the one or more processors receive the input code comprising the audio code through a microphone of the device when the payment card is in proximity to the device.

Clause 10: The auto fill system of any of clauses 7-9, wherein the one or more processors receive the input code upon selection by a user.

Clause 11: The auto fill system of any of clauses 7-10, wherein the payment card information comprises at least one of the following: an account number associated with the payment card, an expiry date of the payment card, a Card Verification Value (CVV), or any combination thereof.

Clause 12: The auto fill system of any of clauses 7-11, wherein the one or more processors authenticate the user upon receiving a One Time Password (OTP) from the user, wherein the OTP is provided to the user by the issuing server of the payment card.

Clause 13: A non-transitory computer readable media including instructions stored thereon that when processed by at least one processor causes the at least one processor to: receive an input code comprising one of an audio code or a QR code from a payment card when the payment card is in proximity to a device hosting an auto fill system; transmit the input code to an issuing server of the payment card; receive payment card information associated with the input code from the issuing server; and auto fill the payment card information at a payment screen of a web application in the device for completing a transaction on the web application.

Clause 14: The non-transitory computer readable media of clause 13, wherein the instructions cause the at least one processor to receive the input code comprising a QR code upon scanning of the QR code using an image capturing unit of the device when the payment card is in proximity to the device.

Clause 15: The non-transitory computer readable media of clause 13 or 14, wherein the instructions cause the at least one processor to receive the input code comprising the audio code through a microphone of the device when the payment card is in proximity to the device.

Clause 16: The non-transitory computer readable media of any of clauses 13-15, wherein the instructions cause the at least one processor to receive the input code upon selection by a user.

Clause 17: The non-transitory computer readable media of any of clauses 13-16, wherein the payment card information comprises at least one of the following: an account number associated with the payment card, an expiry date of the payment card, a Card Verification Value (CVV), or any combination thereof.

Clause 18: The non-transitory computer readable media of any of clauses 13-17, wherein the instructions cause the at least one processor to authenticate a user upon receiving a one time password (OTP) from the user, wherein the OTP is provided to the user by the issuing server of the payment card.

Disclosed herein is a computer-implemented method for auto filling of payment card information in a web application. In some non-limiting embodiments or aspects, the computer-implemented method comprises receiving an input code, by an auto fill system configured in a device associated with a user, comprising one of an audio code or a Quick Response (QR) code from a payment card when the payment card is in proximity to the device. The received input code is transmitted to an issuing server of the payment card. Thereafter, the computer-implemented method comprises retrieving payment card information associated with the input code from the issuing server. Once the payment card information is retrieved, the computer-implemented method comprises auto filling the payment card information at a payment screen of a web application in the device for completing a transaction on the web application.

Further, the present disclosure discloses a system for auto filling of payment card information in a web application. In some non-limiting embodiments or aspects, the system comprises one or more processors and one or more computer-readable media. The one or more computer readable media is communicatively coupled to the one or more processors which stores instructions. Upon execution of the instructions, the one or more processors receive an input code comprising one of an audio code or a QR code from a payment card when the payment card is in proximity to a device hosting the autofill system. Thereafter, the one or more processors transmit the input code to an issuing server of the payment card to retrieve payment card information associated with the input code from the issuing server. Upon receiving the payment card information, the one or more processors auto fill the payment card information at a payment screen of a web application in the device for completing a transaction on the web application.

Further, the present disclosure discloses a non-transitory computer readable media including instructions. In some non-limiting embodiments or aspects, the instructions when processed by at least one processor causes the auto fill system to receive an input code comprising one of an audio code or a QR code from a payment card when the payment card is in proximity to a device hosting the autofill system. Thereafter, the instructions cause the processor to transmit the input code to an issuing server of the payment card to retrieve payment card information associated with the input code from the issuing server. Upon receiving the payment card information from the issuing server, the one or more processors auto fill the payment card information at a payment screen of a web application in the device for completing a transaction on the web application.

The foregoing summary is illustrative only and is not intended to be in any way limiting. In addition to the illustrative aspects, embodiments, and features described above, further aspects, embodiments, and features may become apparent by reference to the drawings and the following detailed description. Additional features and advantages are realized through the techniques of the present disclosure. Other embodiments and aspects of the disclosure are described in detail herein and are considered a part of the claimed disclosure.

### BRIEF DESCRIPTION OF THE DRAWINGS

The novel features and characteristic of the disclosure are set forth in the appended claims. The disclosure itself, however, as well as a preferred mode of use, further objectives, and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1a shows an exemplary architecture for auto filling of payment card information in a web application in accordance with some non-limiting embodiments or aspects of the present disclosure;

FIG. 1b shows an exemplary representation of a payment screen in a web application in accordance with some non-limiting embodiments or aspects of the present disclosure;

FIG. 1c shows an exemplary representation of a payment card in accordance with some non-limiting embodiments or aspects of the present disclosure;

FIG. 2 shows a block diagram of an auto fill system in accordance with some non-limiting embodiments or aspects of the present disclosure;

FIGS. 3a-3c show exemplary representations of a payment screen of a web application illustrating auto fill process in accordance with some non-limiting embodiments or aspects of the present disclosure;

FIG. 4 shows a flowchart illustrating a method for auto filling of payment card information in accordance with some non-limiting embodiments or aspects of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer-readable medium and executed by a computer or processor, whether such computer or processor is explicitly shown. While each of the figures illustrates a particular embodiment for purposes of illustrating a clear example, other embodiments may omit, add to, reorder, and/or modify any of the elements shown in the figures.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

In the following detailed description of the embodiments of the disclosure, reference is made to the accompanying drawings that form a part hereof, and in which are shown by way of illustration specific embodiments in which the disclosure may be practiced. It should be understood, however, that it is not intended to limit the disclosure to the forms disclosed, but on the contrary, the disclosure is to cover all modifications, equivalents, and alternatives falling within the spirit and the scope of the disclosure. It is to be understood that other embodiments may be utilized and that changes may be made without departing from the scope of the present disclosure. The following description is, therefore, not to be taken in a limiting sense.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup, device, or method. In other words, one or more elements in a system or apparatus proceeded by “comprises a” does not, without more constraints, preclude the existence of other elements or additional elements in the system or method.

The terms “includes”, “including”, or any other variations thereof are intended to cover a non-exclusive inclusion such that a setup, device, or method that includes a list of components or steps does not include only those components or steps but may include other components or steps not expressly listed or inherent to such setup, device, or method. In other words, one or more elements in a system or apparatus proceeded by “includes . . . a” does not, without more constraints, preclude the existence of other elements or additional elements in the system or method.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has”, “have”, “having”, or the like are intended to be open-ended terms. Further, the phrase “based on” is intended to mean “based at least in partially on” unless explicitly stated otherwise. The term “some non-limiting embodiments or aspects” means “one or more (but not all) embodiments or aspects of the disclosure(s)” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

As used herein, the terms “communication”, “communicate”, “send”, and/or “receive” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the terms “server” and/or “processor” may refer to one or more computing devices, such as processors, storage devices, and/or similar computer components that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor”, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present disclosure relate to a method and an auto fill system for auto filling of payment card information in a web application. The payment card information may include, but is not limited to, a unique number associated with the payment card, an expiry date of the payment card, and a Card Verification Value (CVV). The payment card information may also include any other information that is specific to the user and the payment card associated with the user. The auto fill system (or system) may be configured in a device associated with a user. As an example, the device may include, but is not limited to, a mobile phone, a tablet, a personal computer, and/or any other device capable of receiving and transmitting data.

In some non-limiting embodiments or aspects, the user may access a web application in the user device and perform a transaction in the web application. The user may reach a payment screen of the web application for making a payment and completing the transaction. At the payment screen, the user may may be requested to provide the payment card information.

In some non-limiting embodiments or aspects, the user may select an auto fill option for automatically filling the payment card information. To automatically fill the payment card information, the user may select one of the audio code or the QR code at the payment screen. Upon selecting, the payment card may be brought in proximity to the device and the system may receive an input code comprising one of an audio code or a QR code from the payment card. The audio code and the QR code may be provided in the payment card by an issuing server associated with the payment card. The system may receive the QR code upon scanning the QR code provided in the payment card using an image capturing unit of the device.

Similarly, the system may receive the audio code by listening to the audio code through a microphone of the device. Upon receiving one of the audio code or the QR code, the system may transmit the input code to an issuing server of the payment card. The system may receive the payment card information associated with the input code from the issuing server. Upon receiving the payment card information, the system may automatically fill the payment card information at a payment screen of a web application in the device for completing a transaction on the web application. In this manner, the present disclosure provides a method and system for automatically filling payment card information in a web application and hence avoids manual errors and reduces time taken to complete a payment process.

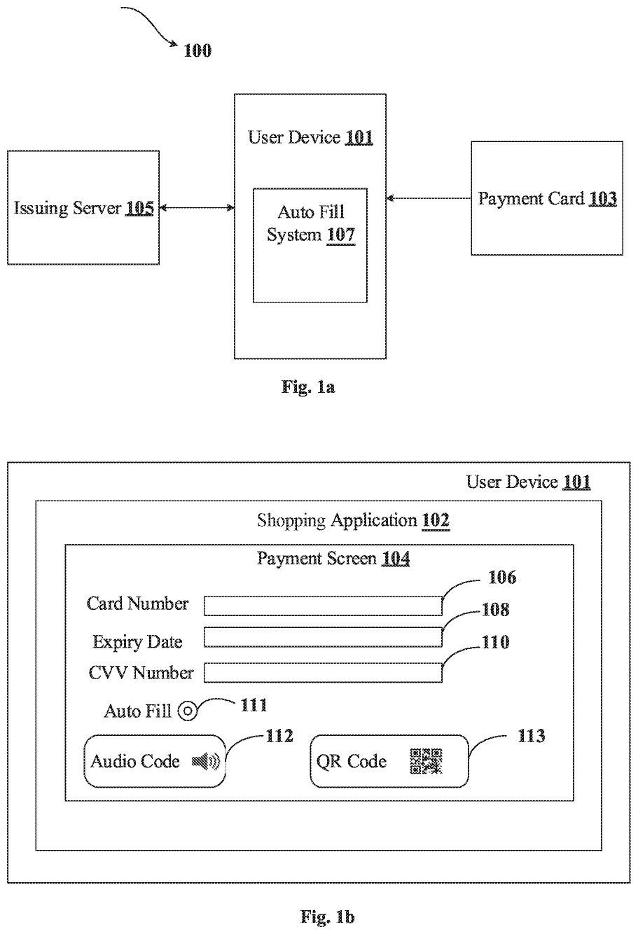

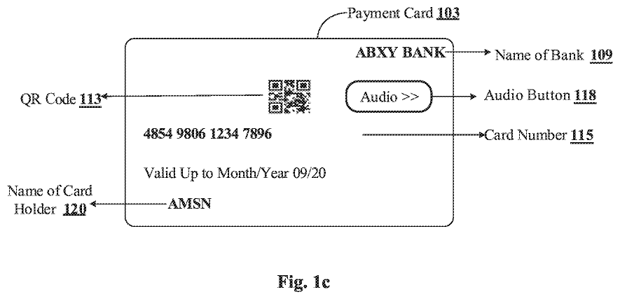

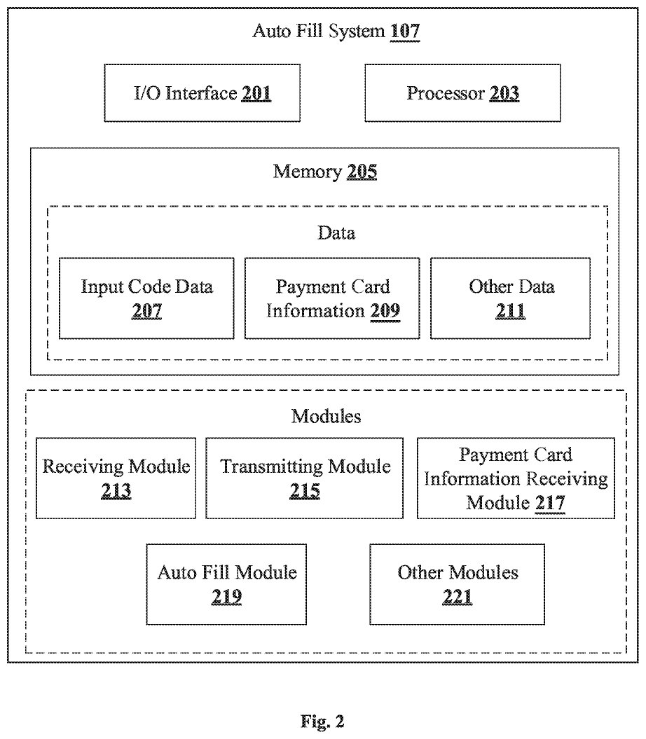

FIG. 1a shows an exemplary architecture 100 for auto filling of payment card information in a web application in accordance with some non-limiting embodiments or aspects of the present disclosure. The exemplary architecture 100 comprises a device 101 (also referred to as “user device”), a payment card 103, and an issuing server 105. The user device 101 may be any computing device associated with a user. As an example, the user device 101 may include, but is not limited to, a mobile phone, a laptop, a tablet, and any other computing device comprising a microphone and an image capturing unit (not shown in FIG. 1a) and capable of receiving and transmitting data. The issuing server 105 may be configured to provide the payment card 103 to the user. The user may use the payment card 103 for making payments. The issuing server 105 may store details of the payment card 103, such as card number, expiry date of the card, Card Verification Value (CVV) number, name of the card holder, financial institution associated with the payment card 103 in a database (not shown in FIG. 1a) associated with the issuing server 105, or any combination thereof. In some non-limiting embodiments or aspects, the issuing server 105 may provide an audio code and/or a Quick Response (QR) code in the payment card 103. The audio code and/or the QR code may be a unique code associated with the payment card 103. The details of the audio code and/or the QR code may also be stored in the database.

In some non-limiting embodiments or aspects, the user device 101 may include an auto fill system 107 for automatically filling payment card 103 information in a payment screen of a web application 102 in the user device 101. As an example, the user may access a web application 102 in the user device 101 and perform a transaction in the web application 102. The user may reach a payment screen 104 of the web application 102 for making a payment and completing the transaction as shown in FIG. 1b. At the payment screen 104, the user may be requested to provide payment card information, such as card number associated with payment card 103 provided to the user, expiry date of the card, and CVV number in respective data fields 106, 108, and 110.

In some non-limiting embodiments or aspects, the user may select auto fill option 111 for automatically providing the payment card information. Once the auto fill option 111 is selected, the options audio code 112 and QR code 113 may be displayed as shown in FIG. 1b. To automatically fill the payment card information, the user may select one of the audio code 112 or the QR code 113. As an example, the user may select the audio code 112 option, and upon selection of the option the auto fill system 107 in the user device 101, the user may receive an input code comprising the audio code 112 from the payment card 103. The exemplary payment card 103 is shown in FIG. 1c. The payment card 103 may include information associated with name of bank 109 such as “ABXY”, name of the card holder 120 such as “AMSN”, card number 115 such as “4854 9806 1234 7896”, audio button 118 and/or QR code 113.

In some non-limiting embodiments or aspects, to receive the audio code 112 from the payment card 103, the payment card 103 may be in proximity to the user device 101. When the payment card 103 is in proximity to the user device 101 and when the user selects the audio button 118, the auto fill system 107 may receive the audio code 112 from the payment card 103. The auto fill system 107 may receive the audio code 112 through microphone of the user device 101. The audio code 112 may be a specific code associated with the payment card 103 and unique to the payment card 103. Similarly, the user may select the QR code 113 option at the payment screen 104. Upon selection of the QR code 113 option, the auto fill system 107 in the user device 101 may receive input code comprising the QR code 113 from the payment card 103. In some non-limiting embodiments or aspects, to receive the QR code 113 from the payment card 103, the payment card 103 may be in proximity to the user device 101. When the payment card 103 is in proximity to the user device 101, the auto fill system 107 may receive the QR code 113 from the payment card 103. The auto fill system 107 may receive the QR code 113 using an image capturing unit in the user device 101. The image capturing unit may scan the QR code 113 provided in the payment card 103. Upon scanning, the auto fill system 107 may receive the QR code 113 from the payment card 103.

In some non-limiting embodiments or aspects, when the user selects one of the audio code 112 or the QR code 113, the issuing server 105 may authenticate the user to verify the user of the payment card 103 using one or more authentication mechanisms. As an example, a one time password (OTP) mechanism may be used for authentication. However, any other authentication mechanisms may be used for the purpose of authentication of the user in the present disclosure. The issuing server 105 may send an OTP to the user device 101. The user may provide the OTP for authentication. If the OTP verification is successful, the auto fill system 107 may automatically fill the payment card information in the web application 102.

In some non-limiting embodiments or aspects, the auto fill system 107 may transmit the received input code to the issuing server 105. Upon receiving the input code, the issuing server 105 may retrieve payment card information corresponding to the received input code from the database associated with the issuing server 105. The auto fill system 107 may receive the payment card information from the issuing server 105. Upon receiving the payment card information, the auto fill system 107 may automatically fill the payment card information in the respective data fields 106, 108, and 110 in the payment screen 104 of the web application 102 for completing the transaction. As an example, the card number 115 may be filled in the data field 106, the expiry date of the payment card 103 may be filled in the date field 108, and the CVV number may be filled in the data field 110.

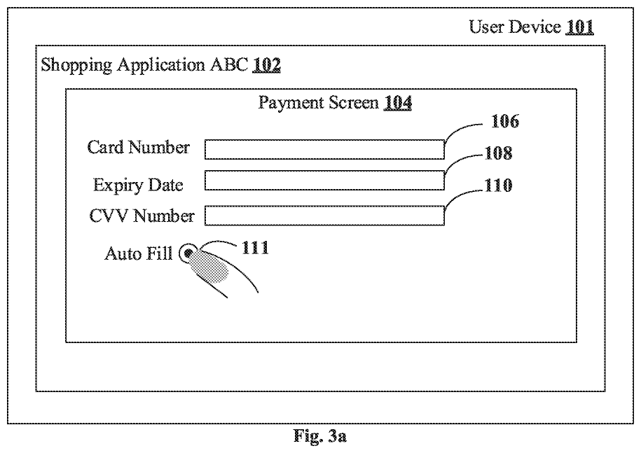

FIG. 2 shows a block diagram of an auto fill system 107 in accordance with some non-limiting embodiments or aspects of the present disclosure. In some implementations, the auto fill system 107 may include data and modules. As an example, the data is stored in a memory 205 of the auto fill system 107 as shown in FIG. 2. In some non-limiting embodiments or aspects, the data may include input code data 207, payment card information 209, and other data 211. In the illustrated FIG. 2, modules are described herein in detail.

In some non-limiting embodiments or aspects, the data may be stored in the memory 205 in the form of various data structures. Additionally, the data can be organized using data models, such as relational or hierarchical data models. The other data 211 may store data, including temporary data and temporary files, generated by the modules for performing the various functions of the auto fill system 107.

In some non-limiting embodiments or aspects, the data stored in the memory 205 may be processed by the modules of the auto fill system 107. The modules may be stored within the memory 205. In an example, the modules communicatively coupled to the processor 203 configured in the auto fill system 107 may also be present outside the memory 205, as shown in FIG. 2 and implemented as hardware. The processor 203 may be configured to perform the functionalities of the auto fill system 107. The processor 203 may receive input code through an I/O interface 201. The I/O interface 201 may also be used for transmitting the input code to an issuing server 105. As used herein, the term modules may refer to an Application Specific Integrated Circuit (ASIC), an electronic circuit, a processor (shared, dedicated, or group), and memory 205 that execute one or more software or firmware programs, a combinational logic circuit, and/or other suitable components that provide the described functionality.

In some non-limiting embodiments or aspects, the modules may include, for example, a receiving module 213, a transmitting module 215, a payment card information receiving module 217, an auto fill module 219, and other modules 221. The other modules 221 may be used to perform various miscellaneous functionalities of the auto fill system 107. It will be appreciated that such aforementioned modules may be represented as a single module or a combination of different modules.

Furthermore, it should be understood that in an implementation, the one or more modules may be stored in the memory 205, without limiting the scope of the disclosure. The modules when configured with the functionality defined in the present disclosure will result in a novel hardware.

In some non-limiting embodiments or aspects, the receiving module 213 may be configured to receive input code from a payment card 103. The input code may comprise one of audio code 112 or QR code 113. The audio code 112 or QR code 113 may be a unique code provided in the payment card 103 by an issuing server 105. The receiving module 213 may receive the input code when one of the audio code 112 or QR code 113 is selected by a user in a web application 102. The received input code is stored as input code data 207. As an example, when the user selects the audio code 112 in the web application 102, the receiving module 213 may receive the audio code 112 from the payment card 103 which may be in proximity to the user device 101. The receiving module 213 may receive the audio code 112 through a microphone of the user device 101 upon selecting the audio button 118 in the payment card 103. Similarly, if the user selects the QR code 113 in the web application 102, then the receiving module 213 may receive the QR code 113 using an image capturing unit (not shown in FIG. 2) in the user device 101. The image capturing unit in the user device 101 may scan the QR code 113 in the payment card 103 to receive the OR code 113 from the payment card 103.

In some non-limiting embodiments or aspects, the transmitting module 215 may be configured to transmit the received input code to the issuing server 105. In some non-limiting embodiments or aspects, the payment card information receiving module 217 may be configured to receive payment card information 209 from the issuing server 105. Upon receiving the input code, the issuing server 105 may retrieve from a database associated with the issuing server 105 the payment card information 209 corresponding to the input code. Each input code may be associated with corresponding payment card information 209. The retrieving module 217 may retrieve the payment card information 209 corresponding to the input code from the issuing server 105.

In some non-limiting embodiments or aspects, the auto fill module 219 may be configured to automatically fill the received payment card information 209 in a payment screen 104 of the web application 102. Upon receiving the payment card information 209, the auto fill module 219 may fill the payment card information 209, such as card number, expiry date of the card, and CVV number in respective data fields in the payment screen 104 of the web application 102.

### Exemplary Scenario

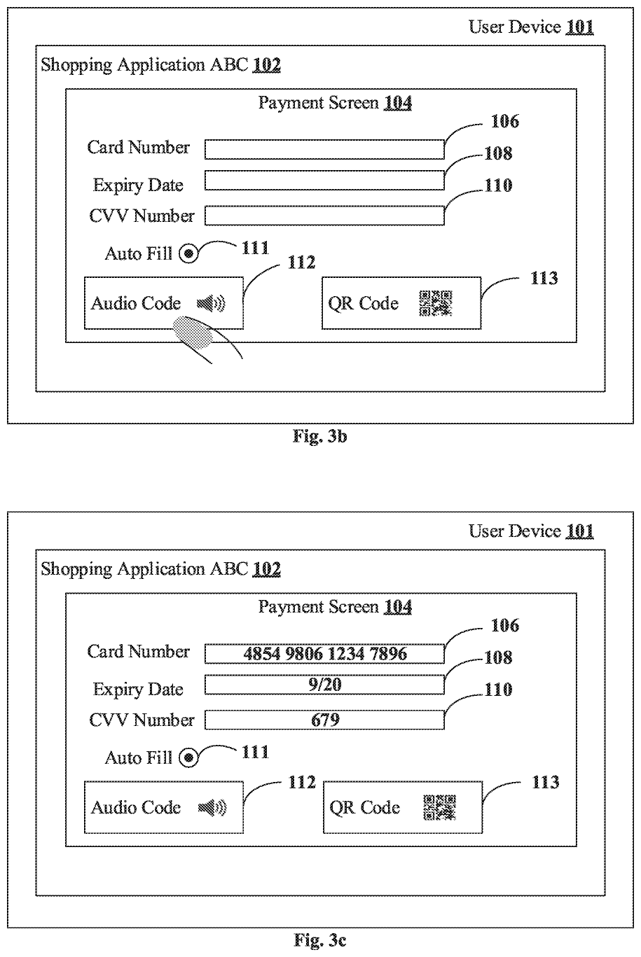

As an example, the user may access an application 102 or a web application 102, such as a shopping application “ABC” in the user device 101, and performs a transaction in the web application 102. The user reaches a payment screen 104 of the shopping application “ABC” for making a payment as shown in FIG. 3a. At the payment screen 104, the user is requested to provide payment card information 209, such as card number associated with payment card 103 provided to the user, expiry date of the card, and CVV number in respective data fields 106, 108, and 110.

In some non-limiting embodiments or aspects, the user selects auto fill option 111 for automatically providing the payment card information 209. Once the auto fill option 111 is selected, the options audio code 112 and QR code 113 may be displayed as shown in FIG. 3b. To automatically fill the payment card information 209, the user selects one of the audio code 112 or the QR code 113. As an example, the user selects the audio code 112 option, as shown in FIG. 3b. Upon selection of this option, the auto fill system 107 in the user device 101 receives input code comprising the audio code 112 from the payment card 103 when the payment card 103 is in proximity to the user device 101. The auto fill system 107 receives the audio code 112 through the microphone of the user device 101. The microphone listens to the audio code 112 from the payment card 103 upon selection of the audio button 118 in the payment card 103. The audio code 112 is a specific unique code associated with the payment card 103 and unique to the payment card 103. As an example, the specific code is “1XAY”.

In this example, the auto fill system 107 transmits the received input code “1XAY” to the issuing server 105. Upon receiving the input code, the issuing server 105 retrieves payment card information 209 corresponding to the received input code from a database associated with the issuing server 105. The auto fill system 107 receives the payment card information 209, such as card number, expiry date, and CVV number associated with the unique code from the issuing server 105. As an example, the card number, expiry date, and CVV number associated with the unique code “1XAY” are “4854 9806 1234 7896”, “09/20”, and “679”, respectively. The issuing server 105 may provide an OTP to the user device 101 for authenticating the user of the payment card 103. The user may provide the received OTP for authentication. If the authentication is successful, the auto fill system 107 may automatically fill the payment card information 209 in the respective data fields 106, 108, and 110 in the payment screen 104 of the shopping application “ABC” 102 for completing the transaction as shown in FIG. 3b.

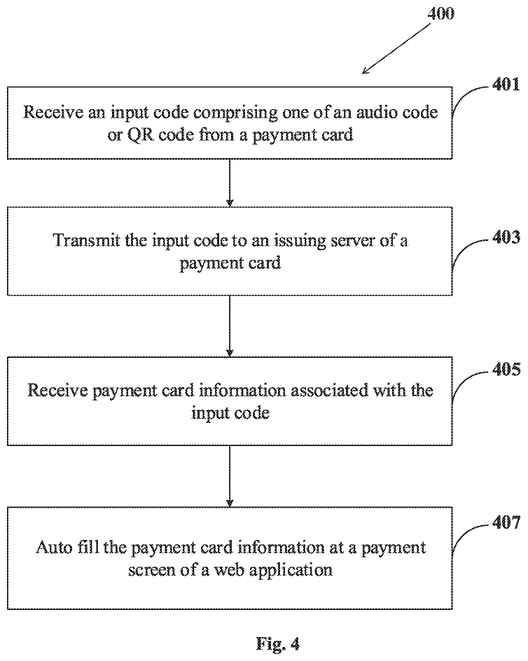

FIG. 4 shows a flowchart illustrating a method of auto filling payment card information in a web application 102 in accordance with some non-limiting embodiments or aspects of the present disclosure. As illustrated in FIG. 4, the computer-implemented method 400 includes one or more blocks illustrating a method of auto filling payment card information 209 in a web application 102. The computer-implemented method 400 (or any computer-implemented method described herein) may be described in the general context of computer executable instructions. Generally, computer executable instructions can include routines, programs, objects, components, data structures, procedures, modules, and functions, which perform specific functions or implement specific abstract data types.

The order of the steps of any computer-implemented method described herein is not intended to be construed as a limitation, and any number of the described method blocks can be combined in any order to implement the computer-implemented method. Additionally, individual blocks/steps may be deleted from the computer-implemented methods without departing from the spirit and scope of the subject matter described herein. Furthermore, the computer-implemented methods can be implemented in any suitable hardware, software, firmware, or combination thereof. This also applies to any computer-implemented method described and/or claimed in the present disclosure.

In the non-limiting embodiment or aspect of the computer-implemented method 400 of FIG. 4, and at block 401, the computer-implemented method 400 may include receiving input code from a user device 101. The input code may comprise one of audio code 112 or a QR code 113. As an example, the user, while performing a transaction in a web application 102 in the user device 101, may reach payment screen 104 of the web application 102 for completing the transaction. At the payment screen 104, the user may select auto fill option 111 and select one of either audio code 112 or QR code 113. When one of the audio code 112 or QR code 113 is selected, the payment card 103 associated with the user may be brought in proximity to the user device 101. When the payment card 103 is in proximity to the user device 101, the auto fill system 107 in the user device 101 may retrieve the input code comprising one of the audio code 112 or QR code 113. The audio code 112 or QR code 113 may be provided in the payment card 103 by the issuing server 105.

At block 403, the computer-implemented method 400 may include transmitting the input code to an issuing server 105. Upon receiving the input code, the auto fill system 107 may transmit the input code to an issuing server 105 associated with the payment card 103. At block 405, the computer-implemented method 400 may include receiving payment card information 209 from an issuing server 105. The auto fill system 107 may receive the payment card information 209 corresponding to the received input code from the issuing server 105. The payment card information 209 may include details of card number, expiry date of the payment card 103, and CVV number associated with the payment card 103.

At block 407, the computer-implemented method may include auto filling the payment card information 209 in a payment screen 104 of a web application 102. The received payment card information 209 corresponding to the input code may be automatically filled in respective data fields in payment screen 104 of the web application 102 upon authentication of the user. The user may be authenticated using one or more authentication mechanisms. As an example, the issuing server 105 may provide an OTP to the user device 101 for authenticating the user of the payment card 103. The user may provide the received OTP for authentication. If the authentication is successful, the auto fill system 107 may automatically fill the payment card information 209 in the respective data fields in the payment screen 104 of the web application 102.

In some non-limiting embodiments or aspects, the present disclosure provides a method and a system to auto fill payment card information in a web application. In some non-limiting embodiments or aspects, the present disclosure employs a method which automatically fills the payment card information by scanning QR code or listening to audio code in the payment card, thereby reducing time taken to complete the payment process in a web application. In some non-limiting embodiments or aspects, the present disclosure employs a method for automatically filling the payment card information and hence avoids manual errors. In some non-limiting embodiments or aspects, the present disclosure provides a method for authenticating a user upon receiving the audio code or QR code from the payment card prior to filling the payment card information in order to verify the genuine user using the payment card for conducting the transaction.

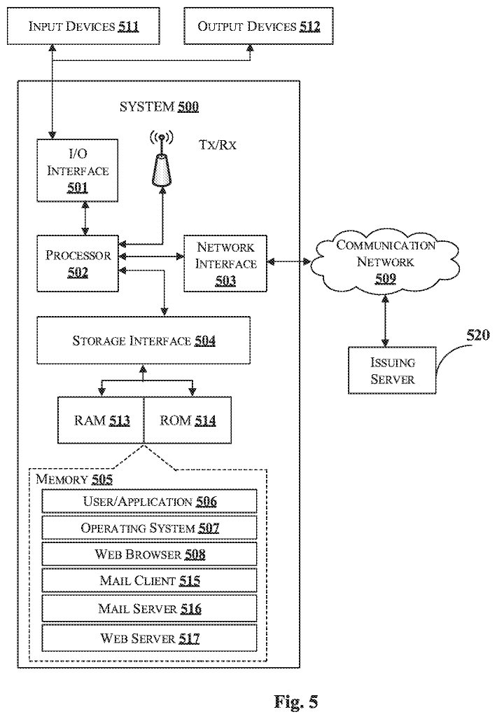

FIG. 5 illustrates a block diagram of an exemplary computer system 500 for implementing embodiments consistent with the present disclosure. In some non-limiting embodiments or aspects, the computer system 500 may be an auto fill system 107 for automatically filling payment card information 209 in a web application 102. The computer system 500 may include a central processing unit (“CPU” or “processor”) 502. The processor 502 may comprise at least one data processor for executing program components for executing user- or system-generated business processes. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via an I/O interface 501. The I/O interface 501 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth®, cellular (e.g., Code-Division Multiple Access (CDMA), High-Speed Packet Access (HSPA+), Global System For Mobile Communications (GSM), Long-Term Evolution (LTE) or the like), etc. Using the I/O interface 501, the computer system 500 may communicate with one or more I/O devices 511 and 512. In some implementations, the I/O interface 501 may be used to connect to the issuing server 520.

In some non-limiting embodiments or aspects, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network 509 can be implemented as one of the several types of networks, such as intranet or Local Area Network (LAN) and such within the organization. The communication network 509 may either be a dedicated network or a shared network, which represents an association of several types of networks that use a variety of protocols, e.g., Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some non-limiting embodiments or aspects, the processor 502 may be disposed in communication with a memory 505 (e.g., Random Access Memory (RAM) 513, Read Only Memory (ROM) 514, etc., as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application 506, an operating system 507, a web browser 508, mail client 515, mail server 516, web server 517, and the like. In some non-limiting embodiments or aspects, computer system 500 may store user/application data 506, such as the data, variables, records, etc. as described in this disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT® WINDOWS® (XP™, VISTA™/7/8, 10 etc.), APPLE® IOS™, GOGGLE® ANDROID™, BLACKBERRY® OS, or the like. A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, APPLE MACINTOSH® operating systems, IBM™ OS/2, MICROSOFT® WINDOWS™ (XP™, VISTA™/7/8, 10 etc.), Unix® X-Windows, web interface libraries (e.g., AJAX™, DHTML™, ADOBE® FLASH™, JAVASCRIPT™, JAVA™, etc.), or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise. The terms “including”, “comprising”, “having”, and variations thereof mean “including but not limited to” unless expressly specified otherwise. The enumerated listing of items does not imply that any or all of the items are mutually exclusive unless expressly specified otherwise. The terms “a”, “an”, and “the” mean “one or more” unless expressly specified otherwise. A description of some non-limiting embodiments or aspects with several components in communication with each other does not imply that all such components are required. On the contrary, a variety of optional components is described to illustrate the wide variety of possible embodiments of the disclosure.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The illustrated operation of FIG. 5 shows certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The computer-implemented method for providing behavioral based authentication can be applied to any one of VR, Augmented Reality (AR), and Mixed Reality (MR) environments, where given user behavior in any one of them can be leveraged to provide better security posture to any system which is enabled by authentication. Further, the present disclosure helps users in developing better trust into virtual POS.

A description of an embodiment with several components in communication with each other does not imply that all such components are required. On the contrary, a variety of optional components is described to illustrate the wide variety of possible embodiments of the disclosure. The method steps and operations discussed herein may describe certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A computer-implemented method comprising:
receiving, with at least one processor, an input code comprising one of an audio code or a QR code from a payment card of a user when the payment card is in proximity to a device associated with the user;
transmitting, with at least one processor, the received input code to an issuing server of the payment card;
receiving, with at least one processor, payment card information associated with the input code from the issuing server; and
auto filling, with at least one processor, the payment card information at a payment screen of a web application in the device for completing a transaction on the web application.

2. The computer-implemented method of claim 1, wherein the input code comprises a QR code, which is received upon scanning the QR code using an image capturing unit of the device when the payment card is in proximity to the device.

3. The computer-implemented method of claim 1, wherein the input code comprises an audio code, which is received through a microphone of the device when the payment card is in proximity to the device.

4. The computer-implemented method of claim 1, wherein the input code is received based on a selection by the user.

5. The computer-implemented method of claim 1, wherein the payment card information comprises at least one of the following: a name of the payment card holder, an account number associated with the payment card, an expiry date of the payment card, a Card Verification Value (CVV), or any combination thereof.

6. The computer-implemented method of claim 1, further comprising authenticating, with at least one processor, the user upon receiving a One Time Password (OTP) from the user, wherein the OTP is provided to the user by the issuing server of the payment card.

7. An auto fill system comprising:
one or more processors; and
one or more computer-readable media, communicatively coupled to the one or more processors storing instructions, which upon execution causes the one or more processors to:
receive an input code comprising one of an audio code or a QR code from a payment card when the payment card is in proximity to a device hosting the auto fill system;
transmit the input code to an issuing server of the payment card;
receive payment card information associated with the input code from the issuing server; and
auto fill the payment card information at a payment screen of a web application in the device for completing a transaction on the web application.

8. The auto fill system of claim 7, wherein the one or more processors receive the input code comprising a QR code upon scanning of the QR code using an image capturing unit of the device when the payment card is in proximity to the device.

9. The auto fill system of claim 7, wherein the one or more processors receive the input code comprising the audio code through a microphone of the device when the payment card is in proximity to the device.

10. The auto fill system of claim 7, wherein the one or more processors receive the input code upon selection by a user.

11. The auto fill system of claim 7, wherein the payment card information comprises at least one of the following: an account number associated with the payment card, an expiry date of the payment card, a Card Verification Value (CVV), or any combination thereof.

12. The auto fill system of claim 7, wherein the one or more processors authenticate the user upon receiving a One Time Password (OTP) from the user, wherein the CTP is provided to the user by the issuing server of the payment card.

13. A non-transitory computer readable media including instructions stored thereon that when processed by at least one processor causes the at least one processor to:
receive an input code comprising one of an audio code or a QR code from a payment card when the payment card is in proximity to a device hosting an auto fill system;
transmit the input code to an issuing server of the payment card;
receive payment card information associated with the input code from the issuing server; and
auto fill the payment card information at a payment screen of a web application in the device for completing a transaction on the web application.

14. The non-transitory computer readable media of claim 13, wherein the instructions cause the at least one processor to receive the input code comprising a QR code upon scanning of the QR code using an image capturing unit of the device when the payment card is in proximity to the device.

15. The non-transitory computer readable media of claim 13, wherein the instructions cause the at least one processor to receive the input code comprising the audio code through a microphone of the device when the payment card is in proximity to the device.

16. The non-transitory computer readable media of claim 13,
wherein the instructions cause the at least one processor to receive the input code upon selection by a user.

17. The non-transitory computer readable media of claim 13, wherein the payment card information comprises at least one of the following: an account number associated with the payment card, an expiry date of the payment card, a Card Verification Value (CVV), or any combination thereof.

18. The non-transitory computer readable media of claim 13, wherein the instructions cause the at least one processor to authenticate a user upon receiving a One Time Password (OTP) from the user, wherein the OTP is provided to the user by the issuing server of the payment card.
